(19) United States
(12) Patent Application Publication
(10) Pub. No.: US 2009/0029153 A1
(43) Pub. Date: Jan. 29, 2009

(54) PLASTIC LENS AND METHOD FOR PRODUCING PLASTIC LENS

(75) Inventors: Shuji Naito, Nagano (JP); Jun Kinoshita, Nagano (JP); Yusuke Kutsukake, Nagano (JP); Katsuyoshi Takeshita, Nagano (JP); Hitoshi Mizuno, Nagano (JP); Hirokazu Tanaka, Fukuoka (JP); Eiko Tanaka, Fukuoka (JP)

Correspondence Address: SUGHRUE MION, PLLC, 2100 PENNSYLVANIA AVENUE, N.W., SUITE 800, WASHINGTON, DC, 20037, US

(73) Assignees: SEIKO EPSON CORPORATON, Tokyo (JP); CATALYSTS & CHEMICALS INDUSTRIES CO., LTD., Kanagawa (JP)

(21) Appl. No.: 11/908,375

(22) PCT Filed: Oct. 28, 2005
(86) PCT No.: PCT/JP2005/020247

§ 371 Date: Apr. 3, 2008

(30) Foreign Application Priority Data
Mar. 11, 2005 (JP) 2005-068634

(51) Int. Cl. B32B 5/16; B05D 5/06

(52) U.S. Cl. 428/328; 427/162

(57) ABSTRACT

Disclosed herein is a plastic lens which exhibits outstanding weather resistance and light resistance with a minimum of deteriorating effect on the organic antireflection thin film formed thereon. The plastic lens is composed of a plastic lens base material, a hard coating layer formed on the plastic lens base material, and an antireflection film formed on the hard coating layer, wherein the hard coating layer is one which is formed from a coating composition comprising inorganic oxide fine particles containing titanium oxide with a rutile-type crystallite and an organosilicon compound as a binder.

### FIELD OF THE INVENTION

The present invention relates to a plastic lens with an antireflection coating of organic thin film and a method for production thereof.

### BACKGROUND OF THE INVENTION

Plastic lenses are widely used in the field of eyeglass because of their lighter weight than glass lenses, good moldability, processability, dyeability, and high safety (with good resistance to breakage).

However, plastic lenses are soft and vulnerable to scratches; therefore, they are provided with a hard surface coating layer for protection from scratches. Moreover, plastic lenses are sometimes provided further with an antireflection film on the hard coating layer to prevent surface reflection. This antireflection film is formed by vapor deposition from an inorganic substance. The surface layers on plastic lenses contribute to the high quality of plastic lenses.

New materials with a high refractive index are being developed to produce thin and light plastic lenses. The most widespread plastic lenses for eyeglass with a high refractive index include urethane-based plastic lenses and episulfide-based plastic lenses. Patent Document 1 (given below) discloses an optical material having both a high refractive index and a high Abbe's number. This optical material is based on a compound which has one or more disulfide linkages (S—S) in one molecule and also has epoxy groups and/or thioepoxy groups. Patent Documents 2 and 3 (given below) disclose plastic lenses having the thiourethane structure which is obtained by reaction between a polyisocyanate compound and a compound (like polythiol) having active hydrogen groups. Patent Document 4 discloses a compound having two or more mercapto groups in the molecule.

The above-mentioned plastic lens with a high refractive index requires that the hard coating layer formed thereon should also have a high refractive index to prevent interference fringes. To meet this requirement, the hard coating layer is usually formed from a coating composition of organosilicon compound incorporated with metal oxide fine particles in sol form. The coating composition is cured after application. One way to impart a high refractive index to the hard coating layer is by using metal oxide fine particles (including titanium dioxide) having a high refractive index, as disclosed in Patent Documents 5 and 6 given below. There are other ways as disclosed in Patent Documents 7 and 8 given below. They involve the use of metal oxide fine particles sol of rutile-type titanium oxide as the coating composition or the use of composite oxide fine particles sol which is formed from a nuclear particle and coating layer covering. The nuclear particles is formed from a composite solid-solution oxide with a rutile-type crystallite of titanium oxide and tin oxide, and a coating layer composed of a composite oxide of silicon oxide and zirconium oxide and/or aluminum oxide, which covers the nuclear particle.

The antireflection film to be formed on the hard coating layer with a high refractive index has recently been disclosed in Patent Document 9 given below. According to this disclosure, the antireflection film is formed from a coating composition incorporated with silica fine particles having a low refractive index, so that the resulting antireflection film (which is an organic thin film) has a refractive index lower than that of the hard coating layer by no less than 0.10 and also has a thickness of 50 to 150 nm.

### [Patent Document 1]

Japanese Patent Laid-open No. Hei 11-322930

### [Patent Document 2]

Japanese Patent Publication No. Hei 4-58489

### [Patent Document 3]

Japanese Patent Laid-open No. Hei 5-148340

### [Patent Document 4]

Japanese Patent Laid-open No. 2001-342252

### [Patent Document 5]

Japanese Patent Laid-open No. Hei 1-301517

### [Patent Document 6]

Japanese Patent Laid-open No. Hei 2-263902

### [Patent Document 7]

Japanese Patent Laid-open No. Hei 2-255532

### [Patent Document 8]

Japanese Patent Laid-open No. 2000-204301

### [Patent Document 9]

Japanese Patent Laid-open No. 2003-222703

### DISCLOSURE OF THE INVENTION

The above-mentioned antireflection film, which is an organic thin film, has a coefficient of thermal expansion close to that of the underlying hard coating layer and hence it excels in heat resistance. However, being a very thin organic film, it is strongly affected by the underlying hard coating layer unlike an inorganic antireflection film formed by vapor deposition. In other words, it is easily deteriorated if the underlying hard coating layer is poor in weather resistance and light resistance and when it becomes deteriorated with time.

The present invention was completed in view of the foregoing. It is an object of the present invention to provide a plastic lens which exhibits outstanding weather resistance and light resistance with a minimum of deteriorating effect on the organic antireflection thin film formed thereon. It is another object of the present invention to provide a method for producing such a plastic lens excelling in weather resistance and light resistance.

The first aspect of the present invention resides in a plastic lens composed of a plastic lens base material, a hard coating layer formed on the plastic lens base material, and an antireflection film formed on the hard coating layer, wherein the hard coating layer is one which is formed from a coating composition containing at least components (A) and (B) defined below: (A) inorganic oxide fine particles having an average particle diameter of 1 to 200 nm and containing titanium oxide with a rutile-type crystallite, (B) an organosilicon compound represented by the general formula of R¹SiX¹₃ (where R¹ denotes an organic group of carbon number 2 or more which has reactive groups capable of polymerization and X¹ denotes a hydrolyzable group), and the antireflection film is an organic thin film which has a refractive index lower than that of the hard coating layer by no less than 0.10 and also has a thickness of 50 to 150 nm.

The second aspect of the present invention resides in the plastic lens as defined in the first aspect, wherein the inorganic oxide fine particles with a rutile-type crystallite contain a composite oxide of titanium oxide and tin oxide or a composite oxide of titanium oxide, tin oxide and silicon oxide, and have an average particle diameter of 1 to 200 nm.

The third aspect of the present invention resides in the plastic lens as defined in the second aspect, wherein the inorganic oxide fine particles include those which have a core/shell type structure formed from (i) a nuclear particle with a rutile-type crystallite composed of a composite oxide of titanium oxide and tin oxide or a composite oxide of titanium oxide, tin oxide and silicon oxide, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers the nuclear particle.

According to the present invention, the inorganic oxide fine particles incorporated into the hard coating layer contain titanium oxide. Because of this composition, the hard coating layer has a high refractive index. In addition, titanium oxide with a rutile-type crystallite (rutile-type titanium oxide) is low in optical activity, unlike titanium oxide with an anatase-type crystallite (anatase-type titanium oxide) which generates a strong oxidizing power to decompose organic matter when it receives light (UV) energy. The optical activity of titanium oxide is due to the fact that electrons in the valance band get excited upon irradiation with light (ultraviolet rays), thereby generating the OH free radicals and HO₂ free radicals which decompose organic matter by their strong oxidizing power. Rutile-type titanium oxide is more stable than anatase-type titanium oxide in terms of thermal energy and hence it generates very few free radicals. Thus the hard coating layer incorporated with rutile-type titanium oxide excels in weather resistance and light resistance, and the antireflection film (which is a thin organic film) is not deteriorated by the hard coating layer. For this reason, the plastic lens according to the present invention is superior in weather resistance and light resistance.

The rutile-type titanium oxide used in the present invention may be in the form of inorganic oxide fine particles with a rutile-type crystallite containing a composite oxide of titanium oxide and tin oxide or a composite oxide of titanium oxide, tin oxide and silicon oxide. Even this rutile-type titanium oxide generates free radicals (mentioned above), therefore, it is desirable that the nuclear particles of said composite oxide should be covered with a composite oxide of silicon oxide and zirconium oxide, a composite oxide of silicon oxide and aluminum oxide or a composite oxide of silicon oxide, zirconium oxide and aluminum oxide. Although the nuclear particles generate free radicals having a strong oxidizing power, such free radicals are unstable and disappear while they pass through the coating layer owing to the catalytic action of the coating layer. Thus the hard coating layer incorporated with the inorganic oxide fine particles is superior in weather resistance and light resistance and it does not deteriorates the antireflection film (which is a thin organic film) formed thereon. For this reason, the plastic lens according to the present invention is superior in weather resistance and light resistance.

The fourth aspect of the present invention resides in the plastic lens as defined in any one of the first to third aspects, wherein the antireflection film is an organic thin film formed from a coating composition containing the components (F) and (G) defined below.

(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1)
(G) silica fine particles having an average particle diameter of 1 to 150 nm.

The component (F), which is an organosilicon compound, functions as a binder for the organic thin film, and the component (G), which is silica fine particles, adjusts the refractive index.

The fifth aspect of the present invention resides in the plastic lens as defined in the fourth aspect, wherein the silica fine particles are hollow ones. Hollow silica fine particles can lower the refractive index of the antireflection film, thereby increasing the difference in refractive index between the antireflection film and the hard coating layer and enhancing the antireflection effect.

The sixth aspect of the present invention resides in the plastic lens as defined in the fifth aspect, wherein the silica fine particles are those which have an average particle diameter of 20 to 150 nm and a refractive index ranging from 1.16 to 1.39.

The seventh aspect of the present invention resides in the plastic lens as defined in any one of the first to sixth aspects, wherein the coating composition for the hard coating layer further contains a polyfunctional epoxy compound as the component (C).

The polyfunctional epoxy compound improves adhesion between the plastic base material and the hard coating layer. It also improves the water resistance of the hard coating layer and imparts flexibility to the hard coating layer. An inorganic vapor-deposited antireflection film functions as a protective film for the hard coating layer; however, the antireflection film (which is a thin organic film) is so thin that the hard coating layer needs water resistance. In addition, the flexibility thus imparted prevents the hard coating layer from cracking and enhances weather resistance as well as water resistance.

The eighth aspect of the present invention resides in the plastic lens as defined in any of the first to seventh aspects, wherein the coating composition for the hard coating layer further contains as the component (D) an organosilicon compound represented by the general formula of R²ₙSiX²₄₋ₙ, (where R² denotes a C₁₋₃ hydrocarbon group, X² denotes a hydrolyzable group, and n is 0 or 1). This organosilicon compound further imparts durability (particularly scratch resistance) to the hard coating layer.

The ninth aspect of the present invention resides in the plastic lens as defined in any one of the first to eighth aspects, wherein the coating composition for the hard coating layer further contains as the component (E) a disilane compound represented by the formula X³₃₋ₘ—Si(R³ₘ)—Y—Si(R⁴ₘ)—X⁴₃₋ₘ (where R³ and R⁴ each denotes a C₁₋₆ hydrocarbon group, X³ and X⁴ each denotes a hydrolyzable group, Y denotes an organic group containing a carbonate group or epoxy group, and m is 0 or 1). This disilane compound increases the curing rate when the coating composition is made into the hard coating layer.

The tenth aspect of the present invention resides in a method for producing a plastic lens, including the steps of forming on the plastic lens base material a hard coating layer from a coating composition containing at least the components (A) and (B) defined below,

(A) inorganic oxide fine particles having an average particle diameter of 1 to 200 nm and containing titanium oxide with a rutile-type crystallite,
(B) an organosilicon compound represented by the general formula of R¹SiX¹₃ (where R¹ denotes an organic group of carbon number 2 or more which has reactive groups capable of polymerization and X¹ denotes a hydrolyzable group), and forming on the hard coating layer an organic thin film as an antireflection film which has a refractive index lower than that of the hard coating layer by no less than 0.10 and also has a thickness of 50 to 150 nm.

The eleventh aspect of the present invention resides in the method for producing a plastic lens as defined in the tenth aspect, wherein the inorganic oxide fine particles with a rutile-type crystallite contain a composite oxide of titanium oxide and tin oxide or a composite oxide of titanium oxide, tin oxide and silicon oxide, and have an average particle diameter of 1 to 200 nm.

The twelfth aspect of the present invention resides in the method for producing a plastic lens as defined in the eleventh aspect, wherein the inorganic oxide fine particles include those which have a core/shell type structure formed from (i) a nuclear particle composed of a composite oxide of titanium oxide and tin oxide or a composite oxide of titanium oxide, tin oxide and silicon oxide, with a rutile-type crystallite, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers the nuclear particle. The inorganic fine particles defined above prevent the organic thin film as the antireflection film from being deteriorated by the hard coating layer. Thus the method gives a plastic lens excelling in weather resistance and light resistance.

The thirteenth aspect of the present invention resides in the method for producing a plastic lens as defined in any one of the tenth to twelfth aspects, wherein the organic thin film as the antireflection film is formed from a coating composition containing the components (F) and (G) defined below.

(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1)
(G) silica fine particles having an average particle diameter of 1 to 150 nm.

The fourteenth aspect of the present invention resides in the method for producing a plastic lens as defined in the thirteenth aspect, wherein the silica fine particles are hollow ones.

The fifteenth aspect of the present invention resides in the method for producing a plastic lens as defined in any of the thirteenth and fourteenth aspects, wherein the silica fine particles are those which have an average particle diameter of 20 to 150 nm and a refractive index ranging from 1.16 to 1.39.

### BEST MODE FOR CARRYING OUT THE INVENTION

The following description is concerned with the embodiments of the present invention for the plastic lens and the method for producing the plastic lens. These embodiments are not intended to restrict the scope of the present invention.

The plastic lens according to the present invention is composed of a plastic lens base material, a hard coating layer formed on the plastic lens base material, and an antireflection film formed on the hard coating layer. It is characterized in the combination of the hard coating layer and the antireflection film. There may be an instance where a primer layer is interposed between the plastic lens base material and the hard coating layer.

The plastic lens base material is a material which has a high refractive index. The material includes not only the currently available ones but also those which will be developed in the future. The material should preferably have a refractive index no lower than 1.60. A currently available material with a high refractive index is a compound having in the molecule one or more disulfide linkages (S—S) and an epoxy group and/or thioepoxy group. It is an optical material which has both a high refractive index and a high Abbe's number. There is another optical material having the thiourethane structure which is obtained by reaction between a poly(thio)isocyanate compound and a compound (such as polythiol compound) having an active hydrogen group. A compound having two or more mercapto groups in the molecule falls under the same category.

The compound having in the molecule one or more disulfide linkages (S—S) and an epoxy group and/or thioepoxy group includes, for example, bis(2,3-epoxypropyl)disulfide and bis(2,3-epithiopropyl)disulfide (which are (thio)epoxy compounds having one disulfide linkage in the molecule) as well as bis(2,3-epithiopropyldithio)methane, bis(2,3-epithiopropyldithio)ethane, bis(6,7-epithio-3,4-dithiaheptane) sulfide, 1,4-dithiane-2,5-bis(2,3-epithiopropyldithiomethyl), 1,3-bis(2,3-epithipropyldithiomethyl)benzene, 1,6-bis(2,3-epithiopropyldithiomethyl)-2-(2,3-epithiopropyldithioethylthio)-4-thiahexane, and 1,2,3-tris(2,3-epithiopropyldithio)propane (which are (thio)epoxy compounds having two or more disulfide linkages in the molecule. These compounds may be used alone or in combination with one another.

The compound having in the molecule two or more iso(thio)cyanate groups includes, for example, aliphatic polyisocyanate compounds, such as ethylene diisocyanate, trimethylene diisocyanate, 2,4,4-trimethylhexane diisocyanate, and hexamethylene diisocyanate; alicyclic polyisocyanate compounds, such as isophorone diisocyanate, aromatic polyisocyanate compounds, such as xylylene diisocyanate; sulfur-containing aliphatic polyisocyanate compounds, such as bis(isocyanatemethyl)sulfide; aromatic sulfide polyisocyanate compounds, such as 2-isocyanate phenyl-4-isocyanate phenylsulfide; aromatic disulfide polyisocyanate compounds, such as bis(4-isocyanatephenyl)disulfide; sulfur-containing alicyclic polyisocyanate compounds, such as 2,5-diisocyanate tetrahydrothiophene; aromatic polyisothiocyanate compounds, such as 1,2-diisothiocyanate benzene; aliphatic polyisothiocyanate compounds, such as 1,2-diisothiocyanate ethane; and sulfur-containing aliphatic polyisothiocyanate compounds, such as thiobis(3-isothiocyanate propane).

The polythiol having two or more thiol groups in the molecule, which undergoes addition reaction with the above-mentioned epoxy groups, thioepoxy groups, and iso(thio)cyanate groups, should preferably be a polythiol compound having two or more mercapto groups in the molecule which is represented by the general formula below. This polythiol compound gives a resin which has a high refractive index and good impact resistance and heat resistance.

R—(SCH₂SH)ₜ

where R denotes an organic residue excluding aromatic rings, and t denotes an integer of 1 or above. The organic residue may be one or more selected from linear or branched aliphatic groups, alicyclic groups, heterocyclic groups, or linear or branched aliphatic groups, alicyclic groups, heterocyclic groups containing sulfur atoms in the chain. The compound should have one or more (preferably two or more) mercaptomethylthio groups in one molecule. The compound may have mercapto groups in addition to the mercaptomethylthio groups.

The polythiol compound represented by the general formula above includes, for example, 1,2,5-trimercapto-4-thiapentane, 3,3-dimercaptomethyl-1,5-dimercapto-2,4-dithiapentane, 3-mercaptomethyl-1,5-dimercapto-2,4-dithiapentane, 3-mercaptomethylthio-1,7-dimercapto-2,6-dithiahepatne, 3,6-dimercaptomethyl-1,9-dimercapto-2,5,8-trithianonane, 3,7-dimercaptomethyl-1,9-dimercapto-2,5,8-trithianonane, 4,6-dimercaptomethyl-1,9-dimercapto-2,5,8-trithianoane, 3-mercaptomethyl-1,6-dimercapto-2,5-dithiahexane, 3-mercaptomethylthio-1,5-dimercapto-2-thiapentane, 1,1,2,2-tetrakis(mercaptomethylthio)ethane, 1,1,3,3-tetrakis(mercaptomethylthio)propane, 1,4,8,11-tetramercapto-2,6,10-trithiaundecane, 1,4,9,12-tetramercapto-2,6,7,11-tetrathiadodecane, 2,3-dithia-1,4-butanedithiol, 2,3,5,6-tetrathia-1,7-heptadithiol, 2,3,5,6,8,9-hexathia-1,10-decanedithiol, 4,5-bis(mercaptomethylthio)-1,3-dithiorane, 4,6-bis(mercaptomethylthio)-1,3-dithiane, 2-bis(mercaptomethylthio)methyl-1,3-dithiaethane, and 2-(2,2-bis(mercaptomethylthio)ethyl)-1,3-dithiaethane. These compounds may be used alone or in combination with one another.

Other polythiols include, for example, 4-mercaptomethyl-3,6-dithio-1,8-octanedithiol represented by the formula (1) below, pentaerythritol tetrakis(3-mercaptopropionate represented by the formula (2) below, and tetrathiol represented by the formula (3) below.

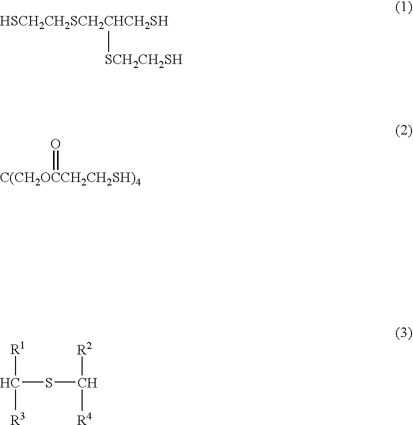

(where R¹, R², R³, and R⁴ each is a group selected from

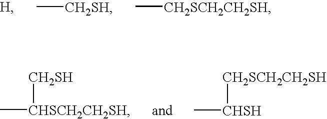

so that one molecule has four or more SH groups.)

The tetrathiol represented by the formula (3) above includes, for example, those compounds represented by the formulas (A) to (G) below.

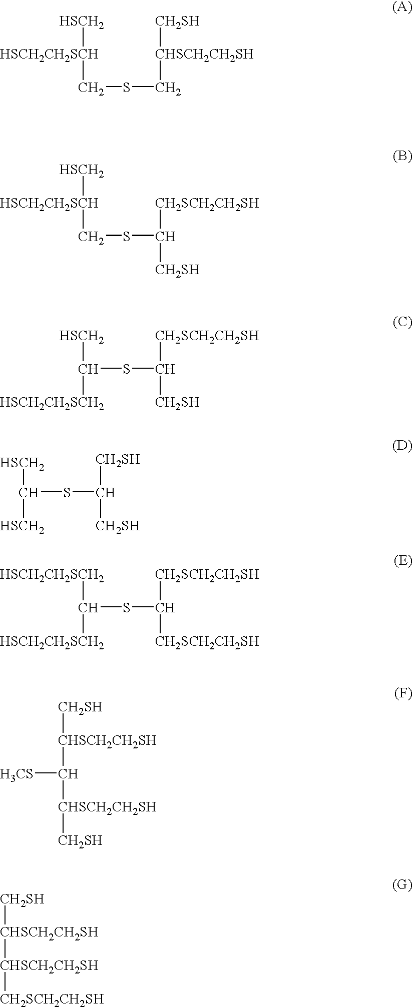

Other polythiols include, for example, di(2-mercaptoethyl)ether, 1,2-ethanedithiol, 1,4-butanedithiol, ethyleneglycol dithioglycolate, trimethylolpropane tris(thioglycolate), pentaerythritol tetrakis(2-mercaptoacetate), dipentaerythritol hexakis(3-mercaptopropionate), dipentaerithrytol hexakis(2-mercaptoacetate), 1,2-dimercaptobenzene, 4-methyl-1,2-dimercaptobenzene, 3,6-dichloro-1,2-dimercaptobenzene, 3,4,5,6-tetrachloro-1,2-dimercapto-benzene, o-xylylenedithiol, m-xylylenedithiol, p-xylylenedithiol, and 1,3,5-tris(3-mercaptopropyl)isocyanurate.

The polymerizable composition to be made into the plastic lens base material may be prepared by mixing a polythiol compound with a (thio)isocyanate compound or a compound having a (thio)epoxy group. The polymerizable composition should preferably be incorporated with a polymerization catalyst for (thio)epoxy group, which includes, for example, tertiary amines (such as dimethylbenzylamine, dimethylcyclohexylamine, diethylethanolamine, dibutylethanolamine, and tridimethylaminomethylphenol), and imidazoles (such as ethylmethylimidazole). The polymerization catalyst for isocyanate and isothiocyanate includes, for example, amine compounds (such as ethylamine, ethylenediamine, triethylamine, and tributylamine) and dibutyltin dichloride and dimethyltin dichloride. Moreover, the polymerizable composition may optionally be incorporated with a light stabilizer and an antioxidant in addition to the polymerization catalyst.

The plastic lens is usually prepared by cast polymerization which involves casting the polymerizable compound into a cavity and subsequent polymerization (curing) by heating or irradiation. The cavity is formed in two round glass molds tightly assembled by means of a gasket or an adhesive tape attached to their sides. In this way it is possible to obtain the plastic lens base material having a high refractive index.

The plastic lens according to the present invention is composed of the plastic lens base material having a high refractive index and a hard coating layer formed thereon. The hard coating layer covering the plastic lens according to the present invention is formed from a coating composition containing at least the components (A) and (B) defined below.

(A) inorganic oxide fine particles having an average particle diameter of 1 to 200 nm and containing titanium oxide with a rutile-type crystallite,
(B) an organosilicon compound represented by the general formula of R¹SiX¹₃ (where R¹ denotes an organic group of carbon number 2 or more which has reactive groups capable of polymerization and X¹ denotes a hydrolyzable group).

To be more specific, the hard coating layer covering the plastic lens according to the present invention is formed from a coating composition containing at least the components (A) and (B) defined below.

(A) inorganic oxide fine particles with a rutile-type crystallite having an average particle diameter of 1 to 200 nm and containing a composite oxide of titanium oxide and tin oxide or a composite oxide of titanium oxide, tin oxide and silicon oxide,
(B) an organosilicon compound represented by the general formula of R¹SiX¹₃ (where R¹ denotes an organic group of carbon number 2 or more which has reactive groups capable of polymerization and X¹ denotes a hydrolyzable group).

The hard coating layer should preferably have a refractive index which is higher or lower than that of the plastic lens (having a high refractive index) by about 0.03 so that it produces no interference fringes. The hard coating layer is usually made to have a high refractive index by incorporation with inorganic oxide fine particles having a high refractive index. To be concrete, the inorganic oxide fine particles are oxides of one or more metals selected from Al, Sn, Sb, Ta, Ce, La, Fe, Zn, W, Zr, In, and Ti (including their mixture), and/or colorless transparent composite oxides containing two or more species of metals. Of these examples, inorganic oxide fine particles containing titanium oxide have a high refractive index and hence have many advantages. That is, they will be adaptive to the future hard coating layer which needs a higher refractive index, and they realize the desired refractive index with a less amount than other metal oxide fine particles. The latter offers the advantage of reducing cracking that occurs during curing due to metal oxides (which deteriorate the toughness of the hard coating layer if present in large amounts). Thus, the inorganic oxide fine particles containing titanium oxide are highly effective in imparting a high refractive index to the hard coating layer.

Unfortunately, the inorganic oxide fine particles containing titanium oxide pose the following problem when used as the metal oxide for the hard coating layer. Titanium oxide gets excited when it receives light (UV) energy, thereby generating a strong oxidizing power which decomposes organic matter. (This characteristic properties are referred to as optical activity hereinafter.) As the result, titanium oxide contained as a constituent in the hard coating layer decomposes organic matter, such as silane coupling agent as another major constituent, on account of its optical activity. This decomposition makes the hard coating layer opaque after use for a long period of time and eventually cracks and peels the hard coating layer. This is undesirable from the standpoint of durability.

One way to suppress the optical activity inherent in inorganic oxide fine particles containing titanium oxide is to incorporate them with metal oxides (of Ce or Fe) which absorb UV rays having a higher wavelength than UV rays to be absorbed by titanium oxide, or which screen UV rays reaching titanium oxide. Another way is to replace the inorganic oxide fine particles with those containing composite oxides. Further another way is to employ Al oxide or Zr oxide which traps free radicals generated by irradiation with UV rays, or to employ Si oxide whose compact film confines free radicals. These measures prevent decomposition of the organic matter, such as silane coupling agent, which is applied onto the hard coating layer. The inorganic oxide fine particles containing titanium oxide, especially composite oxide fine particles containing titanium oxide, contribute to weather resistance; however, they doe not contribute to increasing the refractive index so much as compared with titanium oxide used alone.

Titanium oxide has three kinds of crystal forms called anatase, rutile, and brucite. Titanium oxide of the former two crystal forms is in industrial use but that of the last crystal form is unstable and remains of academic interest.

Titanium oxide in general industrial use is that of rutile crystal form. The consumption of anatase-type titanium oxide is about one-tenth that of rutile-type titanium oxide. Anatase-type titanium oxide finds use in applications where degree of white color is most important and its optical activity can be ignored, and rutile-type titanium oxide is used in applications where the minimal optical activity is most important.

According to the present invention, it is possible to eliminate the disadvantages of titanium oxide arising from its optical activity by selectively employing inorganic oxide fine particles containing titanium oxide with a rutile-type crystallite. Rutile-type titanium oxide has better weather resistance and a higher refractive index than anatase-type titanium oxide, and hence the inorganic oxide fine particles containing rutile-type titanium oxide have a comparatively high refractive index. In addition, rutile-type titanium oxide has lower optical activity than anatase-type titanium oxide. The latter easily gets excited when irradiated with light (UV rays), thereby generating a strong oxidizing power which decomposes organic matter. Such a strong oxidizing power is attributable to OH free radicals and HO₂ free radicals which occur when irradiation with light (UV rays) excites electrons in the valance band in titanium oxide. Rutile-type titanium oxide is more stable (in terms of heat energy) than anatase-type titanium oxide, and hence the former generates less free radicals than the latter. Therefore, the hard coating layer containing rutile-type titanium oxide excels in weather resistance and light resistance and hence it does not deteriorate the antireflection film (which is a thin organic film) formed thereon. Thus, the resulting plastic lens excels in weather resistance and light resistance.

The rutile-type titanium oxide should preferably be in the form of composite oxide with tin oxide and silicon oxide. The composite oxide containing titanium oxide has the rutile crystal form. The amount of titanium oxide and tin oxide in the inorganic oxide fine particles (in terms of TiO₂ and SnO₂ respectively) should be such that the ratio of TiO₂/SnO₂ ranges from 1/3 to 20/1, preferably from 1.5/1 to 13/1 (by weight). If the amount of SnO₂ is reduced from that specified above, the crystal form changes from rutile to anatase and becomes the mixed crystal composed of rutile form and anatase form or becomes the anatase form. By contrast, if the amount of SnO₂ is increased from that specified above, the crystal form becomes an intermediate rutile form between rutile form of titanium oxide and rutile form of tin oxide. This crystal form differs from rutile crystal form of titanium oxide, and the inorganic oxide fine particles containing such titanium oxide have a lower refractive index.

The amount of titanium oxide, tin oxide and silicon oxide in the inorganic oxide fine particles (in terms of TiO₂, SnO₂ and SiO₂ respectively) should be such that the ratio of TiO₂/SnO₂ ranges from 1/3 to 20/1, preferably from 1.5/1 to 13/1 (by weight) and the ratio of (TiO₂+SnO₂)/SiO₂ ranges from 50/45 to 99/1, preferably from 70/30 to 98/2 (by weight). SnO₂ produces the same effect as mentioned above. Silicon oxide improves the stability and dispersibility of the inorganic oxide fine particles. If the amount of SiO₂ is reduced from that specified above, the inorganic oxide fine particles become poor in stability and dispersibility. By contrast, if the amount of SiO₂ is increased from that specified above, the inorganic oxide fine particles improve in stability and dispersibility but undesirably decrease in refractive index.

Even the rutile-type titanium oxide mentioned above generates free radicals. This holds true in the case where the inorganic oxide fine particles including titanium oxide is a composite oxide containing two or more species in addition to titanium oxide.

Consequently, the hard coating layer on the plastic lens according to the present invention should preferably be formed from a coating composition containing at least the following components (A) and (B).

(A) inorganic oxide fine particles having an average particle diameter of 1 to 200 nm, the particle of which is formed from (i) a nuclear particle with a rutile-type crystallite composed of a composite oxide of titanium oxide and tin oxide or a composite oxide of titanium oxide, tin oxide and silicon oxide, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers the nuclear particle.
(B) an organosilicon compound represented by the general formula of R¹SiX¹₃ (where R¹ denotes an organic group of carbon number 2 or more which has reactive groups capable of polymerization and X¹ denotes a hydrolyzable group).

As mentioned above, upon irradiation with light (UV rays), titanium oxide generates OH free radicals and HO₂ free radicals through excitation of electrons in its valence band. These free radicals have a strong oxidizing power to decompose organic matter. Rutile-type titanium oxide generates much less free radicals than anatase-type titanium oxide because the former is more stable than the latter in terms of heat energy. However, rutile-type titanium oxide still generates some free radicals. Therefore, it is desirable to cover the surface of nuclear particles of composite oxide with a composite oxide of silicon oxide and zirconium oxide and/or aluminum oxide. This covering layer extinguishes through its catalytic action the free radicals generated in the nuclear particles (which have a strong oxidizing power but are unstable) while they are passing it.

The content of titanium oxide and tin oxide or the content of titanium oxide, tin oxide and silicon oxide in the nuclear particles is the same as mentioned above. However, the content of silicon oxide, zirconium oxide, and aluminum oxide in the covering layer should preferably be selected as follows.

(a) In the case where the coating layer is formed from a composite oxide of silicon oxide and zirconium oxide, the amount of silicon oxide and zirconium oxide in the coating layer (in terms of SiO₂ and ZrO₂ respectively) should preferably be such that the ratio of SiO₂/ZrO₂ ranges from 50/50 to 99/1, preferably from 65/35 to 90/10 (by weight). If the amount of ZrO₂ exceeds the above-mentioned range, there will be many Zr atoms to trap free radicals but the increased Zr atoms cause strain in the coating layer, thereby preventing the formation of compact coating layer. As the result, the free radicals generated in the nuclear particles migrate to the surface of the inorganic oxide fine particles, thereby oxidizing the organic matter. If the amount of ZrO₂ is less than specified above, the resulting coating layer has a compact structure but does not contain enough Zr atoms to trap free radicals. Thus, the free radicals generated in the nuclear particles migrate to the surface of the inorganic oxide fine particles, thereby oxidizing the organic matter thereon.

(b) In the case where the coating layer is formed from a composite oxide of silicon oxide and aluminum oxide, the amount of silicon oxide and aluminum oxide in the coating layer (in terms of SiO₂ and Al₂O₃ respectively) should preferably be such that the ratio of SiO₂/Al₂O₃ ranges from 60/40 to 99/1, preferably from 68/32 to 95/5 (by weight). If the amount of Al₂O₃ exceeds the above-mentioned range, there will be many Al atoms to trap free radicals but the increased Al atoms prevent the formation of compact coating layer. As the result, the free radicals generated in the nuclear particles migrate to the surface of the inorganic oxide fine particles, thereby oxidizing the organic matter. If the amount of Al₂O₃ is less than specified above, the resulting coating layer has a compact structure but does not contain enough Al atoms to trap free radicals. Thus, the free radicals generated in the nuclear particles migrate to the surface of the inorganic oxide fine particles, thereby oxidizing the organic matter thereon.

(c) In the case where the coating layer is formed from a composite oxide of silicon oxide, zirconium oxide, and aluminum oxide, the amount of silicon oxide, zirconium oxide, and aluminum oxide in the coating layer (in terms of SiO₂, ZrO₂ and Al₂O₃ respectively) should preferably be such that the ratio of SiO₂/(ZrO₂+Al₂O₃) ranges from 98/2 to 6/4, preferably from 95/5 to 7/3 (by weight). If the total amount of ZrO₂ and Al₂O₃ exceeds the above-mentioned range, there will be many Zr and Al atoms to trap free radicals but the increased Zr and Al atoms prevent the formation of compact coating layer. As the result, the free radicals generated in the nuclear particles migrate to the surface of the inorganic oxide fine particles, thereby oxidizing the organic matter. If the total amount of ZrO₂ and Al₂O₃ is less than specified above, the resulting coating layer has a compact structure but does not contain enough Zr and Al atoms to trap free radicals. Thus, the free radicals generated in the nuclear particles migrate to the surface of the inorganic oxide fine particles, thereby oxidizing the organic matter thereon.

Incidentally, the thickness of the coating layer should be 0.02 to 2.27 nm, preferably 0.16 to 1.14 nm, from the above-mentioned standpoint.

The composite oxide constituting the nuclear particles denotes a composite solid solution oxide and/or a composite oxide cluster composed of titanium oxide and tin oxide (including doped composite oxide) or a composite solid solution oxide and/or a composite oxide cluster composed of titanium oxide, tin oxide, and silicon oxide (including doped composite oxide). Moreover, the composite oxide constituting the nuclear particles and/or the coating layer may be a composite hydrate oxide containing OH groups at terminals or one which partly contains the composite hydrated oxide.

The average particle diameter of the inorganic oxide fine particles containing titanium oxide should be in the range of 1 to 200 nm, preferably 5 to 30 nm. With an average particle diameter smaller than 1 nm, the fine particles experience bridging during drying (when the hard coating layer is formed on the plastic lens base material). Bridging prevents uniform shrinkage and reduces the shrinkage rate, giving rise to a hard coating layer lacking required hardness. With an average particle diameter in excess of 200 nm, the fine particles give rise to a white hard coating layer which is not suitable for optical use.

The inorganic oxide fine particles containing rutile-type titanium oxide may be used alone or in combination with other inorganic oxide fine particles, which are oxides of one or more metals selected from Si, Al, Sn, Sb, Ta, Ce, La, Fe, Zn, W, Zr, and In (including their mixture), and/or composite oxides containing two or more species of metals.

Typical examples of the inorganic oxide fine particles may be in the form of inorganic oxide fine particles containing rutile-type titanium oxide having an average particle diameter of 1 to 200 nm which are colloidal dispersion in a dispersing agent (such as water, alcohol, and any other organic solvents). A commercial product is available from Catalysts & Chemicals Industries Co., Ltd. under a trade name of “Optolake”. It is a sol of inorganic oxide fine particles having an average particle diameter of 8 to 10 nm, the particle of which is formed from (i) a nuclear particle with a rutile-type crystallite composed of a composite oxide of titanium oxide and tin oxide or a composite oxide of titanium oxide, tin oxide and silicon oxide, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers the nuclear particle.

The inorganic oxide fine particles may be surface-treated with an organosilicon compound, amine compound, or carboxylic acid (such as tartaric acid and malic acid) so as to improve their dispersion stability in the coating composition.

The organosilicon compounds for surface coating includes monofunctional, difunctional, trifunctional, and tetrafunctional silane compounds. Surface treatment may be accomplished with or without hydrolysis of hydrolyzable groups. Surface treatment should preferably be accomplished such that hydrolyzable groups react with —OH groups of the fine particles; however, hydrolyzable groups may partly remain without hydrolysis.

The amine compound includes, for example, ammonium, alkylamine (such as ethylamine, triethylamine, isopropylamine, and n-propylamine), aralkylamine (such as benzylamine), alicyclic amine (such as piperidine), and alkanolamine (such as monoethanolamine and triethanolamine).

These organosilicon compounds and amine compounds should preferably be added in an amount of 1 to 15 wt % for the inorganic oxide fine particles.

The kind and amount of the inorganic oxide fine particles are determined by the desired hardness and refractive index. The amount should preferably be 5 to 80 wt %, especially 10 to 50 wt % for solids in the hard coating composition. With an excessively small amount, the fine particles do not impart sufficient wear resistance to the coating film. With an excessively large amount, the fine particles cause cracking to the coating film and adversely affect dyeability.

The organosilicon compound as the component (B) constituting the coating composition for the hard coating layer is one which is represented by the general formula R¹SiX¹₃. This organosilicon compound functions as a binder for the hard coating layer.

In the above formula, R¹ denotes a C₂₋₆ organic group having a reactive group capable of polymerization, which is selected from vinyl group, allyl group, acrylic group, methacrylic group, 1-methylvinyl group, epoxy group, mercapto group, cyano group, isocyano group, and amino group. X¹ denotes a hydrolyzable functional group, which includes, for example, alkoxyl group (such as methoxy group, ethoxy group, and methoxyethoxy group), halogen group (such as chloro group and bromo group), and acyloxy group. There should be three hydrolyzable groups, so that they form the three-dimensional crosslinked structure. If the number of hydrolyzable groups is two or less, the resulting coating film is poor in wear resistance.

The organosilicon compound as the component (B) includes, for example, vinyltrialkoxysilane, vinyltrichlorosilane, vinyltri(β-methoxy-ethoxy)silane, allyltrialkoxysilane, acryloxypropyltrialkoxysilane, methacryloxypropyltrialkoxysilane, γ-glycidoxypropyltrialkoxysilane, β-(3,4-epoxycyclohexyl)-ethyltrialkoxysilane, mercaptopropyltrialkoxysilane, and γ-aminopropyltrialkoxysilane.

These silane compounds as the component (B) may be used in combination with one another. Moreover, they should be used after hydrolysis for their enhanced effect.

The coating composition for the hard coating layer should preferably be incorporated with a polyfunctional epoxy compound as the component (C).

The polyfunctional epoxy compound improves adhesion between the hard coating layer and the plastic base material. It also improves the water resistance of the hard coating layer and imparts flexibility to the hard coating layer. The antireflection film formed from an inorganic material by deposition functions as a protective film for the hard coating layer; however, the antireflection film in the form of organic thin film is very thin and hence the hard coating layer needs water resistance. In addition, the antireflection film in the form of organic thin film is formed from the coating solution by application and subsequent baking (for curing). Baking sometimes causes cracking to the hard coating layer. (The hard coating layer experiences baking twice, once for itself and once for the antireflection film.) The hard coating layer is also subject to cracking upon exposure to heat cycle and UV rays. The polyfunctional epoxy compound, which imparts flexibility to the hard coating layer, prevents the occurrence of cracking and hence improves yields and weather resistance.

The polyfunctional epoxy compound includes the following: aliphatic epoxy compound, such as 1,6-hexanediol diglycidyl ether, ethyleneglycol diglycidyl ether, diethyleneglycol diglycidyl ether, triethyleneglycol diglycidyl ether, tetraethyleneglycol diglycidyl ether, nonaethyleneglycol diglycidyl ether, propyleneglycol diglycidyl ether, dipropyleneglycol diglycidyl ether, tripropyleneglycol diglycidyl ether, tetrapropyleneglycol diglycidyl ether, nonapropyleneglycol diglycidyl ether, neopentylglycol diglycidyl ether, diglycidyl ether of neopentylglycol hydroxypivalic acid ester, trimethylolpropane diglycidyl ether, trimethylolpropane triglycidyl ether, glycerol diglycidyl ether, glycerol triglycidyl ether, diglycerol diglycidyl ether, diglycerol triglycidyl ether, diglycerol tetraglycidyl ether, pentaerythritol triglycidyl ether, pentaerythritol tetraglycidyl ether, dipentaerythritol tetraglycidyl ether, sorbitol tetraglycidyl ether, and triglycidyl ether of tris(2-hydroxyethyl)isocyanate;

alicyclic epoxy compound, such as isophoronediol diglycidyl ether and bis-2,2-hydroxycyclohexylpropane diglycidyl ether;
aromatic epoxy compound, such as resorcin diglycidyl ether, bisphenol A diglycidyl ether, bisphenol F diglycidyl ether, bisphenol S diglycidyl ether, o-phthalic acid diglycidyl ether, phenol novolak polyglycidyl ether, and cresol novolak polyglycidyl ether.

Of these epoxy compounds, the following aliphatic epoxy compounds are preferable.

1,6-hexanediol diglycidyl ether, diethyleneglycol diglycidyl ether, triethyleneglycol diglycidyl ether, trimethylolpropane triglycidyl ether, glycerol diglycidyl ether, glycerol triglycidyl ether, and triglycidyl ether of tris(2-hydroxyethyl)isocyanate.

The amount of the polyfunctional epoxy compound should be 4 to 22 wt %, particularly 5 to 20 wt %, for solids. If the amount of the polyfunctional epoxy compound is excessively small, the hard coating layer is poor in adhesion to the underlying base material, water resistance, and flexibility. Poor flexibility may lead to cracking during baking when the antireflection film (with a low reactive index) is formed on the hard coating layer. If the amount of the polyfunctional epoxy compound is excessively large, the hard coating layer is poor in hardness.

The coating composition for the hard coating layer should preferably be incorporated with the component (D), which is an organosilicon compound represented by the general formula of R²ₙSiX²₄₋ₙ.

In the above formula, R² denotes a C₁₋₃ hydrocarbon group, such as vinyl group, allyl group, acrylic group, methacrylic group, 1-methylvinyl group, epoxy group, mercapto group, cyano group, isocyano group, amino group, methyl group, ethyl group, and propyl group. Also, X² denotes a hydrolyzable group, which includes alkoxyl groups, such as methoxy group, ethoxy group, and methoxyethoxy group, halogen groups, such as chloro group and bromo group, and acyloxy group. n is 0 or 1. Examples of the silane compound include tetraalkoxy silane, vinyltrialkoxy silane, methyltrialkoxy silane, and allyltrialkoxy silane.

The organosilicon compound as the component (D) improves durability (especially scratch resistance) of the coating film. The amount of the component (D) should preferably be 2 to 15 wt % for solids. With an amount less than 2 wt %, it produces no effect. With an amount more than 15 wt %, it makes the coating film opaque and causes cracking. These compounds may be used alone or in combination with one another. Also, the organosilicon compound as the component (D) should preferably be used after hydrolysis.

The coating composition for the hard coating layer should preferably be incorporated further with the component (E) which is a disilane compound represented by the general formula of X³₃₋ₘ—Si(R³ₘ)—Y—Si(R⁴ₘ)—X⁴₃₋ₘ.

In the formula above, R³ and R⁴ each denotes a C₁₋₆ hydrocarbon group, such as methyl group, ethyl group, butyl group, vinyl group, and phenyl group. X³ and X⁴ each denotes a hydrolyzable group, such as alkoxyl groups including methoxy group, ethoxy group, and methoxyethoxy group, halogen groups including chloro group and bromo group, and acyloxy group. m is 0 or 1. Y denotes an organic group having a carbonate group or epoxy group. It is exemplified below.

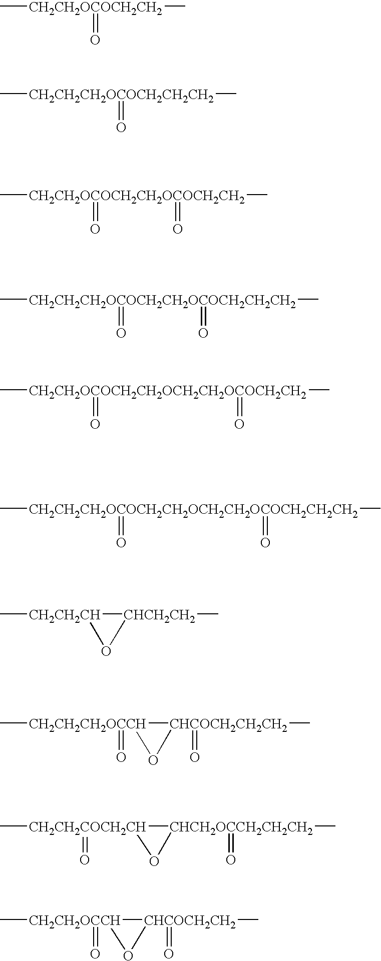

These disilane compounds may be synthesized by any known process, which involves addition reaction between diallyl carbonate and trichlorosilane and ensuing alkoxylation. Another process involves addition of trichlorosilane to a compound having functional groups capable of addition reaction at both terminals and an epoxidizable functional group in the inner part and ensuing alkoxylation.

The disilane compound increases the curing rate of the coating composition. The increased curing rate (and hence the reduced curing time) lowers the possibility of dust and impurities sticking to the coating surface during application, thereby improving yields. Moreover, it produces the effect of improving dyeability, reducing the amount of polyfunctional epoxy compound, and making defects (such as scratches) on the base material less visible.

The amount of the disilane compound should preferably be 3 to 40 wt %, particularly 5 to 20 wt %, for solids. An excessively small amount does not produce the effect of accelerating reaction. An excessively large amount makes the coating film poor in water resistance and shortens the pot life of the coating solution.

The coating composition for the hard coating layer may be incorporated with a curing catalyst (although curing is possible without catalyst). Preferred curing catalysts include perchlorate (such as perchloric acid, ammonium perchlorate, and magnesium perchlorate), acetylacetonate having Cu(II), Zn(II), Co(II), Ni(II), Be(II), Ce(III), Ta(III), Ti(III), Mn(III), La(III), Cr(III), V(III), Co(III), Fe(III), Al(III), Ce(IV), Zr(IV), or V(IV) as the central metal atom, amine, amino acid (such as glycine), Lewis acid, and metal salt of organic acid. Of these examples, magnesium perchlorate and acetylacetonate of Al(III) or Fe(III) are preferable from the standpoint of curing condition and pot life. The amount of the catalyst should preferably be 0.01 to 5.0 wt % for solids.

The coating composition for the hard coating layer may optionally be diluted with a solvent, such as alcohol, ester, ketone, ether, and aromatic solvent.

The coating composition for the hard coating layer may optionally be incorporated with the following additives in small amounts in addition to the above-mentioned components. Metal chelate compound, surface active agent, antistatic agent, UV absorber, antioxidant, disperse dye, oil-soluble dye, pigment, photochromic compound, and light-heat stabilizing agent such as hindered amine and hindered phenol. These additives improve the coating properties and curing rate of the coating solution and the performance of cured film.

Before application of the coating composition, it is desirable to perform surface treatment on the plastic lens base material to improve adhesion between the base material and the coating film. Such surface treatment includes treatment with an alkaline or acid solution or a surface active agent, polishing with inorganic or organic fine particles, and application of primer or plasma.

Application of the coating composition may be accomplished by dipping, spin coating, spray coating, roll coating, or flow coating. After application, the coating solution is dried by heating at 40 to 200° C. for several hours. Thus there is obtained the desired coating film.

The thickness of the hard coating layer should preferably be 0.05 to 30 μm. A thickness smaller than 0.05 μm is not enough to realize the fundamental performance. A thickness larger than 30 μm is detrimental to surface smoothness and optical performance.

The plastic lens according to the present invention has an antireflection film on the hard coating layer. The present invention is characterized in that the antireflection film has a refractive index which is lower than that of the hard coating layer by no less than 0.10 and that the antireflection film is an organic thin film having a thickness of 50 to 150 nm.

The organic thin film constituting the antireflection film is not specifically restricted so long as it has the above-specified refractive index and thickness. It may be formed from a silicone resin, acrylic resin, epoxy resin, urethane resin, melamine resin, or the like, alone or in combination with other resins. It may also be formed from monomers of such resins alone or in combination with other monomers. Silicone resin is preferable in view of its heat resistance, chemical resistance and scratch resistance. The antireflection film of silicone resin has a low refractive index. It is desirable to incorporate the silicone resin with an inorganic matter in the form of fine particles to improve surface hardness and adjust refractive index. Such an inorganic matter includes colloidal sol, such as silica sol, magnesium fluoride sol, and calcium fluoride sol.

A desirable organic thin film is formed by wet process from the coating composition containing the components (F) and (G) defined below.

(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1)
(G) silica fine particles having an average particle diameter of 1 to 150 nm.

An inorganic film formed by dry process (such as vapor deposition and sputtering) is poor in heat resistance on account of a large difference in coefficient of thermal expansion from the underlying organic hard coating layer. By contract, the organic thin antireflection film formed by wet process is less vulnerable to cracking during heating on account of a small difference in coefficient of thermal expansion from the hard coating layer. Therefore, it excels in heat resistance. In addition, wet process needs no vacuum apparatus and complex facilities and hence is easy to carry out.

The organic group represented by R⁵ in the formula above (which is an organic group having reactive groups capable of polymerization) include, for example, vinyl group, allyl group, acrylic group, methacrylic group, epoxy group, mercapto group, cyano group, and amino group. The C₁₋₆ hydrocarbon group represented by R⁶ includes, for example, methyl group, ethyl group, butyl group, vinyl group, and phenyl group. The hydrolyzable group represented by X⁵ includes, for example, alkoxyl group such as methoxy group, ethoxy group, and methoxyethoxy group, halogen group such as chloro group and bromo group, and acyloxy group.

The organosilicon compound as the component (F) includes, for example, vinyltrialkoxysilane, vinyltrichlorosilane, vinyltri(β-methoxy-ethoxy)silane, allyltrialkoxysilane, acryloxypropyltrialkoxysilane, methacryloxypropyltrialkoxysilane, methacryloxypropyldialkoxymethylsilane, γ-glycidoxypropyltrialkoxysilane, β-(3,4-epoxycyclohexyl)-ethyltrialkoxysilane, mercaptopropyltrialkoxysilane, γ-aminopropyltrialkoxysilane, N-(aminoethyl)-γ-aminopropylmethyldialkoxysilane, and tetralkoxysilane.

The silica fine particles as the component (G) include, for example, silica sol which is prepared by dispersing silica fine particles (having an average particle diameter of 1 to 150 nm) into water, alcohol, or an organic solvent to make colloid. It is desirable to prepare the silica sol from silica fine particles having pores or interstices inside. Such hollow or porous silica fine particles have a lower refractive index than solid silica fine particles on account of gas or solvent contained therein which has a lower refractive index than silica itself. Therefore, the coating film containing such hollow silica fine particles has a low refractive index as desired.

The above-mentioned hollow or porous silica fine particles will be described in more detail in the following. The silica fine particles can be produced by the method disclosed in Japanese Patent Laid-open No. 2001-233611. It is desirable to select those particles which have an average particle diameter of 20 to 150 nm and a refractive index of 1.16 to 1.39. With an average particle diameter smaller than 20 nm, the silica particles do not give the desired low refractive index on account of small porosity. With an average particle diameter larger than 150 nm, the silica particles make the organic thin film hazy.

The hollow or porous silica fine particles are commercially available from Catalysts & Chemicals Industries Co., Ltd. under a trade name of “THRULYA” and “L'ECUME”. The commercial product is disperse sol containing hollow or porous silica fine particles having an average particle diameter of 20 to 150 nm and a refractive index of 1.16 to 1.39.

The coating composition for the antireflection film may be incorporated with, in addition to the components (F) and (G), a variety of resins, such as polyurethane resin, epoxy resin, melamine resin, and polyolefin resin, urethane acrylate resin, and epoxyacrylate resin, a variety of monomers, such as methacrylate, acrylate, epoxy, and vinyl, for such resins. It is desirable to add a fluorine-containing polymer or a fluorine-containing monomer to reduce the refractive index. The fluorine-containing polymer should preferably be one which is obtained by polymerizing a fluorine-containing vinyl monomer and also be one which has functional groups polymerizable with other components.

The coating composition for the layer having a low refractive index may optionally be diluted with a solvent, such as water, alcohol, ester, ketone, ether, and aromatic solvent.

The coating composition for the layer with a low refractive index, which contains an organosilicon compound as the component (F) and silica fine particles as the component (G), may optionally be incorporated with a small amount of the following additives. Curing catalyst, surface active agent, antistatic agent, UV absorber, antioxidant, light-heat stabilizing agent such as hindered amine and hindered phenol, disperse dye, oil-soluble dye, fluorescent dye, and pigment. These additives improve the coating properties and the performance of cured film.

The wet process for forming the antireflection film with a low refractive index includes, for example, dipping, spinning, spraying, and flowing. The dipping or spinning method is desirable to form a thin film (50 to 150 nm thick) on a curved surface of plastic lens.

When the antireflection film with a low refractive index is formed on the hard coating layer, it is desirable to perform pretreatment on the surface of the hard coating layer. The pretreatment includes, for example, polishing, UV-ozone cleaning, and plasma etching, which make the surface of the hard coating layer hydrophilic (with a contact angle θ not larger than 60°).

The antireflection film is formed in the following manner. First, an organosilicon compound as the component (F) is diluted with an organic solvent, and the resulting solution is given water or dilute hydrochloric acid or acetic acid to hydrolyze the organosilicon compound, if necessary. Silica fine particles as the component (G) are dispersed in an organic solvent to prepare a colloid dispersion with a concentration of 5 to 50 wt %. The colloidal dispersion is added to the solution of the organosilicon compound. The resulting mixture is given a surface active agent, UV light absorber, antioxidant, etc., if necessary. After thorough stirring, there is obtained the desired coating solution. The concentration (solids basis) of the coating solution is adjusted to 0.5 to 15 wt %, preferably 1 to 10 wt %, for the amount of solids after curing. With a concentration higher than 15 wt %, the coating solution does not give a desired film thickness even though the lifting rate is reduced in the dipping process or the number of revolution is increased in the spinning process, and the film thickness is unnecessarily large. With a concentration lower than 0.5 wt %, the coating solution does not give a desired film thickness even though the lifting rate is increased in the dipping process or the number of revolution is reduced in the spinning process, and the film thickness is unnecessarily small. In addition, increasing the lifting rate or reducing the number of revolution causes uneven coating on the lens surface, and this defect cannot be eliminated by addition of a surface active agent.

After application onto the plastic lens, the coating solution is cured by heating or irradiation with UV rays. In this way the antireflection film is obtained. However, curing by heating is desirable. The heating temperature is properly determined in consideration of the make-up of the coating composition and the heat resistance of the plastic lens. It is usually 50 to 200° C., preferably 80 to 140° C.

The thickness of the antireflection film should be in the range of 50 to 150 nm. With a thickness outside this range, the antireflection film does not produce its effect. The refractive index of the antireflection film should be such that the difference from that of the underlying hard coating layer is not smaller than 0.10, preferably not smaller than 0.15, more preferably not smaller than 0.20. To be concrete, the refractive index should be in the range of 1.30 to 1.45.

The method for producing the plastic lens according to the present invention is summarized as follows.

(1) The method includes a first step of forming on the plastic lens base material a hard coating layer from a coating composition containing at least the components (A) and (B) defined below and a second step of forming on the hard coating layer an organic thin film as an antireflection film which has a refractive index lower than that of the hard coating layer by not less than 0.10 and also has a thickness of 50 to 150 nm,
(A) inorganic oxide fine particles having an average particle diameter of 1 to 200 nm and containing titanium oxide of rutile crystal structure,
(B) an organosilicon compound represented by the general formula of R¹SiX¹₃ (where R¹ denotes an organic group of carbon number 2 or more which has reactive groups capable of polymerization and X¹ denotes a hydrolyzable group).
(2) The method includes a first step of forming on the plastic lens base material a hard coating layer from a coating composition containing at least the components (A) and (B) defined below and a second step of forming on the hard coating layer an organic thin film as an antireflection film which has a refractive index lower than that of the hard coating layer by not less than 0.10 and also has a thickness of 50 to 150 nm,
(A) inorganic oxide fine particles having an average particle diameter of 1 to 200 nm and containing a composite oxide of titanium oxide and tin oxide or a composite oxide of titanium oxide, tin oxide and silicon oxide, with a rutile-type crystallite.
(B) an organosilicon compound represented by the general formula of R¹SiX¹₃ (where R¹ denotes an organic group of carbon number 2 or more which has reactive groups capable of polymerization and X¹ denotes a hydrolyzable group).
(3) The method for producing the plastic lens according to the present invention is characterized in that the inorganic oxide fine particles defined in (2) above include those which have a core/shell type structure formed from (i) a nuclear particle composed of a composite oxide of titanium oxide and tin oxide or a composite oxide of titanium oxide, tin oxide and silicon oxide, with a rutile-type crystallite, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers the nuclear particle.
(4) The method for producing the plastic lens according to the present invention is characterized in that the organic thin film as the antireflection film is formed from a coating composition containing the components (F) and (G) defined below.
(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1)
(G) silica fine particles having an average particle diameter of 1 to 150 nm.
(5) The method for producing the plastic lens according to the present invention is characterized in that the silica fine particles defined in (4) above are hollow or porous ones.
(6) The method for producing the plastic lens according to the present invention is characterized in that the silica fine particles defined in (5) above are those which have an average particle diameter of 20 to 150 nm and a refractive index ranging from 1.16 to 1.39.

### EXAMPLES

The present invention will be described in more detail with reference to examples below, which are not intended to restrict the scope thereof.

### Examples 1 to 8 and Comparative Examples 1 to 5

Examples 1 to 8 and Comparative Examples 1 to 5 that follow demonstrate the effect produced by each component in the coating composition for the hard coating layer to be formed on the plastic lens according to the present invention. The resulting plastic lenses were evaluated in the following manner.

(1) Moisture Resistance

Lens samples are allowed to stand in a thermo-hygrostat at 60° C. and 100 RH % for 7 days. (Model PR-1G, from Espec Kabushiki Kaisya) Those samples which show no change in the surface are rated as “good”, and those samples which show slight change in the surface but are practically acceptable are rated as “fair”.

(2) Weather Resistance

Lens samples are exposed to a sunshine weather meter (Model WEL-SUN-HC, from Suga Test Instrument Co., Ltd.) with a xenon lamp for 80 hours. They are visually examined for surface change and rated according to the following criteria.
⊚: no change
◯: cloudy
Δ: cracking
X: peeling

(3) Adhesion of surface treating layer (hard coating layer and low refractive index layer).

The surface treating layer (hard coating layer and low refraction film) is tested for adhesion to the lens base material according to JIS D-0202 (cross cut test). The surface of a lens sample is scribed with a knife in vertical and horizontal directions at intervals of 1 mm, so that 100 squares are made, each measuring 1 mm by 1 mm. A piece of cellophane tape (“Cello-tape” from Nichiban Co., Ltd.) is firmly pressed against the squares and abruptly pulled in the direction at an angle of 90° to the surface. The number of squares of coating film remaining on the surface is visually counted. Adhesion is rated according to the following criterion.
⊚: 100% squares remain
◯: not less than 95% nor less than 100% squares remain
Δ: not less than 50% nor less than 95% squares remain
X: less than 50% squares remain

(4) Scratch Resistance Test

Lens samples are rubbed with steel wool (steel wool #0000 from Nippon Steel Wool Co., Ltd.) to-and-fro ten times under a load of 1 kg. The rubbed samples are visually examined for scratches and rated according to the following criterion.

“1” (poor) to “10” (good)
⊚: 10 to 8
◯: 7 to 6
Δ: to 4
X: 3 to 1

(1) Preparation of Coating Solution (H-1) for the Hard Coating Layer.

A mixture was made from 264 parts of propylene glycol methyl ether and 1000 parts of “Optolake 1120Z (11RU-7/A8)” commercially available from Catalysts & Chemicals Industries Co., Ltd. (“Optolake 1120Z (11RU-7/A8)” is a sol containing 20 wt % of inorganic oxide fine particles (having an average particle diameter of 10 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 226 parts of γ-glycidoxypropyltrimethoxysilane and 40 parts of glycerol polyglycidyl ether (“Denacol EX-313” from Nagase Chemicals, Ltd.). To the resulting mixed solution was added dropwise with stirring 62 parts of 0.1N aqueous solution of hydrochloric acid. The solution was stirred for 4 hours and allowed to stand for 24 hours. To the aged solution were added 3 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-1) for the hard coating layer.

(2) Preparation of Coating Solution (H-2) for the Hard Coating Layer.

A mixture was made from 146 parts of propylene glycol methyl ether and 1000 parts of “Optolake 1120Z (11RU-7/A8)” commercially available from Catalysts & Chemicals Industries Co., Ltd. (“Optolake 1120Z (11RU-7/A8)” is a sol containing 20 wt % of inorganic oxide fine particles (having an average particle diameter of 10 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 226 parts of γ-glycidoxypropyltrimethoxysilane and 101 parts of tetramethoxysilane. To the resulting mixed solution was added dropwise with stirring 120 parts of 0.1N aqueous solution of hydrochloric acid. The solution was stirred for 4 hours and allowed to stand for 24 hours. To the aged solution were added 2 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-2) for the hard coating layer.

(3) Preparation of Coating Solution (H-3) for the Hard Coating Layer.

A mixture was made from 178 parts of propylene glycol methyl ether and 1000 parts of “Optolake 1120Z (11RU-7/A8)” commercially available from Catalysts & Chemicals Industries Co., Ltd. (“Optolake 1120Z (11RU-7/A8)” is a sol containing 20 wt % of inorganic oxide fine particles (having an average particle diameter of 10 nm) dispersed in methanol, the particle of which is formed from a nuclear particle composed of composite of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 170 parts of _{Y}-glycidoxypropyltrimethoxysilane, 101 parts of tetramethoxysilane, and 40 parts of glycerol polyglycidyl ether (“Denacol EX-313” from Nagase Chemicals, Ltd.). To the resulting mixed solution was added dropwise with stirring 104 parts of 0.1N aqueous solution of hydrochloric acid. The solution was stirred for 4 hours and allowed to stand for 24 hours. To the aged solution were added 2.5 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-3) for the hard coating layer.

(4) Preparation of Coating Solution (H-4) for the Hard Coating Layer.

A mixture was made from 261 parts of propylene glycol methyl ether and 1000 parts of “Optolake 1120Z (11RU-7/A8)” commercially available from Catalysts & Chemicals Industries Co., Ltd. (“Optolake 1120Z (11RU-7/A8)” is a sol containing 20 wt % of inorganic oxide fine particles (having an average particle diameter of 10 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 170 parts of _{Y}-glycidoxypropyltrimethoxysilane, 63 parts of disilane compound (“NSK-100” from Tokuyama Co., Ltd.), and 40 parts of glycerol polyglycidyl ether (“Denacol EX-313” from Nagase Chemicals, Ltd.). To the resulting mixed solution was added dropwise with stirring 60 parts of 0.1N aqueous solution of hydrochloric acid. The solution was stirred for 4 hours and allowed to stand for 24 hours. To the aged solution were added 2.5 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-4) for the hard coating layer.

(5) Preparation of Coating Solution (H-5) for the Hard Coating Layer.

A mixture was made from 264 parts of propylene glycol methyl ether and 1030 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 10 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 226 parts of _{Y}-glycidoxypropyltrimethoxysilane and 40 parts of glycerol polyglycidyl ether (“Denacol EX-313” from Nagase Chemicals, Ltd.). To the resulting mixed solution was added dropwise with stirring 62 parts of 0.1N aqueous solution of hydrochloric acid. The solution was stirred for 4 hours and allowed to stand for 24 hours. To the aged solution were added 3 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-5) for the hard coating layer.

(6) Preparation of Coating Solution (H-6) for the Hard Coating Layer.

A mixture was made from 264 parts of propylene glycol methyl ether and 1000 parts of “Optolake 1120AL (11RU-7/A8)” commercially available from Catalysts & Chemicals Industries Co., Ltd. (“Optolake 1120AL (11RU-7/A8)” is a sol containing 20 wt % of inorganic oxide fine particles (having an average particle diameter of 10 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and aluminum oxide, and whose surface is further modified with a coupling agent.) The resulting mixture was further mixed with 226 parts of _{Y}-glycidoxypropyltrimethoxysilane and 40 parts of glycerol polyglycidyl ether (“Denacol EX-313” from Nagase Chemicals, Ltd.). To the resulting mixed solution was added dropwise with stirring 62 parts of 0.1N aqueous solution of hydrochloric acid. The solution was stirred for 4 hours and allowed to stand for 24 hours. To the aged solution were added 3 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-6) for the hard coating layer.

(7) Preparation of Coating Solution (H-7) for the Hard Coating Layer.

A mixture was made from 264 parts of propylene glycol methyl ether and 1030 parts of “Optolake 1120ZAL (8RU-25/A8)” commercially available from Catalysts & Chemicals Industries Co., Ltd. (“Optolake 1120ZAL (8RU-25/A8)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide, zirconium oxide and aluminum oxide, and whose surface is further modified with a coupling agent.) The resulting mixture was further mixed with 226 parts of γ-glycidoxypropyltrimethoxysilane and 40 parts of glycerol polyglycidyl ether (“Denacol EX-313” from Nagase Chemicals, Ltd.). To the resulting mixed solution was added dropwise with stirring 62 parts of 0.1N aqueous solution of hydrochloric acid. The solution was stirred for 4 hours and allowed to stand for 24 hours. To the aged solution were added 3 parts of Fe(III) acetyl acetonate and 5 parts of silicone surfactant (“L-7001” from Nippon Unicar Company Limited). The solution was stirred for 4 hours and allowed to stand for 24 hours. Thus there was obtained a coating solution (abbreviated as H-7) for the hard coating layer.

(8) Preparation of Coating Solution (H-8) for the Hard Coating Layer.

A coating solution (abbreviated as H-8) for the hard coating layer was prepared in the same way as in preparation of the coating solution (H-1) for the hard coating layer, except that the sol of inorganic oxide fine particles was replaced by a sol containing 20 wt % of inorganic oxide fine particles (having an average particle diameter of 8 nm) dispersed in methanol, the particle of which is formed from a nuclear particle composed of composite oxide of titanium oxide and silicon oxide with an anatase-type crystallite, and a coating layer composed of composite oxide of silicon oxide and zirconium oxide, and whose surface is further modified with a coupling agent. The composite oxide sol is commercially available from Catalysts & Chemicals Industries Co., Ltd. under a trade name of “Optolake 1120Z (U-25/A8)”.

(9) Preparation of Coating Solution (H-9) for the Hard Coating Layer.

A coating solution (abbreviated as H-9) for the hard coating layer was prepared in the same way as in preparation of the coating solution (H-2) for the hard coating layer, except that the sol of inorganic oxide fine particles was replaced by a sol containing 20 wt % of inorganic oxide fine particles (having an average particle diameter of 8 nm) dispersed in methanol, the particle of which is formed from a nuclear particle composed of composite oxide of titanium oxide and silicon oxide with an anatase-type crystallite, and a coating layer composed of composite oxide of silicon oxide and zirconium oxide, and whose surface is further modified with a coupling agent. The composite oxide sol is commercially available from Catalysts & Chemicals Industries Co., Ltd. under a trade name of “Optolake 1120Z (U-25/A8)”.

(10) Preparation of Coating Solution (H-10) for the Hard Coating Layer.

A coating solution (abbreviated as H-10) for the hard coating layer was prepared in the same way as in preparation of the coating solution (H-3) for the hard coating layer, except that the sol of inorganic oxide fine particles was replaced by a sol containing 20 wt % of inorganic oxide fine particles (having an average particle diameter of 8 nm) dispersed in methanol, the particle of which is formed from a nuclear particle composed of composite oxide of titanium oxide and silicon oxide with an anatase-type crystallite, and a coating layer composed of composite oxide of silicon oxide and zirconium oxide, and whose surface is further modified with a coupling agent. The composite oxide sol is commercially available from Catalysts & Chemicals Industries Co., Ltd. under a trade name of “Optolake 1120Z (U-25/A8)”.

(11) Preparation of Coating Solution (H-11) for the Hard Coating Layer.

A coating solution (abbreviated as H-11) for the hard coating layer was prepared in the same way as in preparation of the coating solution (H-4) for the hard coating layer, except that the sol of inorganic oxide fine particles was replaced by a sol containing 20 wt % of inorganic oxide fine particles (having an average particle diameter of 8 nm) dispersed in methanol, the particle of which is formed from a nuclear particle composed of composite oxide of titanium oxide and silicon oxide with an anatase-type crystallite, and a coating layer composed of composite oxide of silicon oxide and zirconium oxide, and whose surface is further modified with a coupling agent. The composite oxide sol is commercially available from Catalysts & Chemicals Industries Co., Ltd. under a trade name of “Optolake 1120Z (U-25/A8)”.

(12) Preparation of Coating Solution (C-1) for Low Refraction Film.

A mixture was made from 18.8 g of propylene glycol monomethyl ether (PGME for short hereinafter) and 8.1 g of γ-glycidoxytrimethoxysilane. To the resulting mixture was added dropwise with stirring 2.2 g of 0.1N aqueous solution of hydrochloric acid. The resulting solution was stirred for 5 hours. To this solution was added 20.7 g of silica sol containing 20 wt % solids, which is commercially available from Catalysts & Chemicals Industries Co., Ltd. under a trade name of “THRULYA 1420”. This silica sol is a dispersion of hollow silica fine particles (having an average particle diameter of 60 nm) in isopropanol. After thorough mixing, the solution was incorporated with 0.04 g of Al(C₅H₇O₂)₃ as a polymerization catalyst and 0.015 g of silicone surfactant (“L7604” from Nippon Unicar Company Limited). After stirring and dissolution, there was obtained a stock coating solution containing 20% solids. This stock coating solution (35.3 g) was diluted with 114.7 g of PGME solution containing 300 ppm of silicone surfactant (“L7604” from Nippon Unicar Company Limited). After thorough stirring, there was obtained a coating solution for the low refraction film which contains about 4.7% solids. This coating solution is designated as C-1.

(13) Preparation of Coating Solution (C-2) for Low Refraction Film.

A mixture was made from 18.8 g of propylene glycol monomethyl ether (PGME for short hereinafter) and 8.1 g of γ-glycidoxytrimethoxysilane. To the resulting mixture was added dropwise with stirring 2.2 g of 0.1N aqueous solution of hydrochloric acid. The resulting solution was stirred for 5 hours. To this solution was added 20.7 g of silica sol containing 20 wt % solids, which is commercially available from Catalysts & Chemicals Industries Co., Ltd. under a trade name of “Oscal 1435”. This silica sol is a dispersion of solid silica fine particles (having an average particle diameter of 45 nm) in isopropanol. After thorough mixing, the solution was incorporated with 0.04 g of Al(C₅H₇O₂)₃ as a polymerization catalyst and 0.015 g of silicone surfactant (“L7604” from Nippon Unicar Company Limited). After stirring and dissolution, there was obtained a stock coating solution containing 20% solids. This stock coating solution (35.3 g) was diluted with 114.7 g of PGME solution containing 300 ppm of silicone surfactant (“L7604” from Nippon Unicar Company Limited). After thorough stirring, there was obtained a coating solution for the low refraction film which contains about 4.7% solids. This coating solution is designated as C-2.

### Example 1

The above-mentioned H-1 solution was applied to a plastic lens with a refractive index of 1.67 by dipping (with a lifting rate of 35 cm/min). The plastic lens is a product of Seiko Epson Corporation made from the lens base material for Seiko Super Sovereign (SSV for short hereinafter).

Dipping was followed by air drying at 80° C. for 30 minutes and baking at 120° C. for 180 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 1 was satisfactory in all of moisture resistance, weather resistance, surface layer adhesion, and scratch resistance.

### Example 2

The above-mentioned H-2 solution was applied to SSV by dipping (with a lifting rate of 35 cm/min). Dipping was followed by air drying at 80° C. for 30 minutes and baking at 120° C. for 120 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 2 was satisfactory in all of moisture resistance, weather resistance, surface layer adhesion, and scratch resistance.

### Example 3

The above-mentioned H-3 solution was applied to SSV by dipping (with a lifting rate of 35 cm/min). Dipping was followed by air drying at 80° C. for 30 minutes and baking at 120° C. for 180 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 3 was satisfactory in all of moisture resistance, weather resistance, surface layer adhesion, and scratch resistance.

### Example 4

The above-mentioned H-4 solution was applied to SSV by dipping (with a lifting rate of 35 cm/min). Dipping was followed by air drying at 80° C. for 20 minutes and baking at 120° C. for 180 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 4 was satisfactory in all of moisture resistance, weather resistance, surface layer adhesion, and scratch resistance.

### Example 5

The above-mentioned H-5 solution was applied to SSV by dipping (with a lifting rate of 35 cm/min). Dipping was followed by air drying at 80° C. for 30 minutes and baking at 120° C. for 120 minutes. Thus there was obtained a hard coating layer, 2.5 μm thick. To the thus obtained lens base material was applied the above-mentioned C-1 solution by dipping (with a lifting rate of 10 cm/mm). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 5 was satisfactory in all of moisture resistance, weather resistance, surface layer adhesion, and scratch resistance.

### Example 6

The above-mentioned H-6 solution was applied to SSV by dipping (with a lifting rate of 35 cm/min). Dipping was followed by air drying at 80° C. for 30 minutes and baking at 120° C. for 120 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 6 was satisfactory in all of moisture resistance, weather resistance, surface layer adhesion, and scratch resistance.

### Example 7

The above-mentioned H-7 solution was applied to SSV by dipping (with a lifting rate of 35 cm/min). Dipping was followed by air drying at 80° C. for 30 minutes and baking at 120° C. for 120 minutes. Thus there was obtained a hard coating layer, 2.5 μm thick. To the thus obtained lens base material was applied the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.37.

The thus obtained lens was tested for moisture resistance, weather resistance, surface layer adhesion, and scratch resistance according to the method mentioned above. The lens obtained in Example 7 was satisfactory in all of moisture resistance, weather resistance, surface layer adhesion, and scratch resistance.

### Example 8

The above-mentioned H-1 solution was applied to SSV by dipping (with a lifting rate of 35 cm/min). Dipping was followed by air drying at 80° C. for 30 minutes and baking at 120° C. for 120 minutes. Thus there was obtained a hard coating layer, 2.5 μm thick. To the thus obtained lens base material was applied the above-mentioned C-2 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the coating layer was 1.46.

The thus obtained lens was tested for moisture resistance, weather resistance, surface layer adhesion, and scratch resistance according to the method mentioned above. The lens obtained in Example 8 was satisfactory in all of moisture resistance, weather resistance, surface layer adhesion, and scratch resistance. However, the lens in Example 8 tends to be higher in reflectivity than the lenses in Examples 1 to 7. (The reflectivity was measured as the bottom of the reflectivity curve.)

### Comparative Example 1

The above-mentioned H-8 solution was applied to SSV by dipping (with a lifting rate of 35 cm/min). Dipping was followed by air drying at 80° C. for 30 minutes and baking at 120° C. for 180 minutes. Thus there was obtained the hard coating layer, 2.5 μm thick. The thus obtained lens base material was coated with the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the low refraction film was 1.37.

The thus obtained lens was tested for moisture resistance, weather resistance, surface layer adhesion, and scratch resistance according to the method mentioned above. The lens obtained in Comparative Example 1 was satisfactory in moisture resistance, surface layer adhesion, and scratch resistance, but was poor in weather resistance.

### Comparative Example 2

The above-mentioned H-9 solution was applied to SSV by dipping (with a lifting rate of 35 cm/min). Dipping was followed by air drying at 80° C. for 20 minutes and baking at 120° C. for 180 minutes. Thus there was obtained the hard coating layer, 2.5 μm thick. The thus obtained lens base material was coated with the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the low refraction film was 1.37.

The thus obtained lens was tested for moisture resistance, weather resistance, surface layer adhesion, and scratch resistance according to the method mentioned above. The lens obtained in Comparative Example 2 was satisfactory in moisture resistance, surface layer adhesion, and scratch resistance, but was poor in weather resistance.

### Comparative Example 3

The above-mentioned H-10 solution was applied to SSV by dipping (with a lifting rate of 35 cm/min). Dipping was followed by air drying at 80° C. for 30 minutes and baking at 120° C. for 180 minutes. Thus there was obtained the hard coating layer, 2.5 μm thick. The thus obtained lens base material was coated with the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the low refraction film was 1.37.

The thus obtained lens was tested for moisture resistance, weather resistance, surface layer adhesion, and scratch resistance according to the method mentioned above. The lens obtained in Comparative Example 3 was satisfactory in moisture resistance, surface layer adhesion, and scratch resistance, but was poor in weather resistance.

### Comparative Example 4

The above-mentioned H-11 solution was applied to SSV by dipping (with a lifting rate of 35 cm/min). Dipping was followed by air drying at 80° C. for 30 minutes and baking at 120° C. for 180 minutes. Thus there was obtained the hard coating layer, 2.5 μm thick. The thus obtained lens base material was coated with the above-mentioned C-1 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the low refraction film was 1.37.

The thus obtained lens was tested for moisture resistance, weather resistance, surface layer adhesion, and scratch resistance according to the method mentioned above. The lens obtained in Comparative Example 4 was satisfactory in moisture resistance, surface layer adhesion, and scratch resistance, but was poor in weather resistance.

### Comparative Example 5

The above-mentioned H-8 solution was applied to SSV by dipping (with a lifting rate of 35 cm/min). Dipping was followed by air drying at 80° C. for 30 minutes and baking at 120° C. for 180 minutes. Thus there was obtained the hard coating layer, 2.5 μm thick. The thus obtained lens base material was coated with the above-mentioned C-2 solution by dipping (with a lifting rate of 10 cm/min). Dipping was followed by baking at 100° C. for 180 minutes. Thus there was obtained a lens with a low refraction film. The thickness of the coating layer was 90 nm and the refractive index of the low refraction film was 1.46.

The thus obtained lens was tested for moisture resistance, weather resistance, surface layer adhesion, and scratch resistance according to the method mentioned above. The lens obtained in Comparative Example 5 was poor in weather resistance. Moreover, the lens tends to be high in reflectivity, which was measured as the bottom of the reflectivity curve.

Table 1 below shows the make-up of the coating composition for the hard coating layer. Table 2 below shows the results of evaluation of samples in Examples and Comparative Examples.

TABLE 1

| | | Glycerol | | γ-glycidoxy- | |
|---|---|---|---|---|---|
| | Rutile | polyglycidyl | Disilane | propyltrimeth- | Tetrameth- |
| | Ti sol | ether | compound | oxysilane | oxysilane |
| H-1 | 50 | 10 | — | 40 | — |
| H-2 | 50 | — | — | 40 | 10 |
| H-3 | 50 | 10 | — | 30 | 10 |
| H-4 | 50 | 10 | 10 | 30 | — |
| H-5 | 50 | 10 | — | 40 | — |
| H-6 | 50 | 10 | — | 40 | — |
| H-7 | 50 | 10 | — | 40 | — |

TABLE 2

| | Coating | Coating | | | | | |
|---|---|---|---|---|---|---|---|
| | solution | solution | | | | | Reflectivity |
| | for hard | for low | | | Adhesion | | at bottom of |
| | coating | refraction | Moisture | Weather | of surface | Scratch | reflectivity |
| | layer | film | resistance | resistance | layer | resistance | curve |
| Example 1 | H-1 | C-1 | Good | ⊚ | ⊚ | ◯ | Low |
| Example 2 | H-2 | C-1 | Fair | ⊚ | ⊚ | ⊚ | Low |
| Example 3 | H-3 | C-1 | Good | ⊚ | ⊚ | ⊚ | Low |
| Example 4 | H-4 | C-1 | Good | ⊚ | ⊚ | ◯ | Low |
| Example 5 | H-5 | C-1 | Good | ⊚ | ⊚ | ⊚ | Low |
| Example 6 | H-6 | C-1 | Good | ⊚ | ⊚ | ◯ | Low |
| Example 7 | H-7 | C-1 | Good | ⊚ | ⊚ | ⊚ | Low |
| Example 8 | H-1 | C-2 | Good | ⊚ | ⊚ | ◯ | High |
| Comparative | H-8 | C-1 | Good | X | ⊚ | ◯ | Low |
| Example 1 | | | | | | | |
| Comparative | H-9 | C-1 | Fair | X | ⊚ | ⊚ | Low |
| Example 2 | | | | | | | |
| Comparative | H-10 | C-1 | Good | X | ⊚ | ⊚ | Low |
| Example 3 | | | | | | | |
| Comparative | H-11 | C-1 | Good | X | ⊚ | ◯ | Low |
| Example 4 | | | | | | | |
| Comparative | H-8 | C-2 | Good | X | ⊚ | ◯ | High |
| Example 5 | | | | | | | |

It is apparent from Table 2 that the plastic lens samples in Comparative Examples 1 to 5, which have the hard coating layer formed from the H-8 to H-11 coating solutions of inorganic oxide fine particles containing anatase-type titanium oxide, are poor in weather resistance although the titanium oxide constitutes composite oxide fine particles with other oxides and assumes the form of composite oxide covered with a coating layer. The plastic lens sample in Example 8, which has a low refraction film formed from the C-2 coating solution of solid silica fine particles, has a high reflectivity measured at the bottom of the reflectivity curve. The plastic lens sample in Comparative Example 5, which has the hard coating layer formed from the H-8 coating solution of inorganic oxide fine particles containing anatase-type titanium oxide and also has a low refraction film formed from the coating solution C-2 of solid silica fine particles, has high reflectivity measured at the bottom of the reflectivity curve and is poor in weather resistance.

In addition, the plastic lens samples in Example 2 and Comparative Example 2, which have the hard coating layer formed from the coating solution not containing the polyfunctional epoxy compound as the component (C), are slightly poor in moisture resistance. Also, the plastic lens samples in Examples 2 and 3 and Comparative Examples 2 and 3, which have the hard coating layer formed from the coating solution containing the organosilicon compound as the component (D), excel particularly in scratch resistance.

### Examples 9 to 11 and Comparative Examples 6 and 7

These examples demonstrate how the polyfunctional epoxy compound varies in its effect depending on its amount. Incidentally, the plastic lens samples were evaluated in the following manner.

(1) Heat Resistance Test (Crack Occurring Temperature):

The lenses obtained in the examples were fitted into the eyeglass frame, and the assembled eyeglass is heated in an oven at 40° C. for 30 minutes. After heating, the eyeglass was allowed to stand at room temperature for 30 minutes. The lenses were visually examined for cracking by using a camera obscura. If no cracking occurred, heating was repeated for 30 minutes in the oven at a temperature raised by 10° C. and the visual examination was repeated. This procedure was repeated until the heating temperature reached 100° C. The temperature at which obvious cracking occurred was designated as crack occurring temperature. The results were rated according to the following criterion.
⊚: very high heat resistance (with a crack occurring temperature of 100° C. or above)
◯: high heat resistance (with a crack occurring temperature of 80 to 90° C.)
X: low heat resistance (with a crack occurring temperature equal to or lower than 70° C.)

(2) Adhesion Test:

Before adhesion test, lens samples were exposed to a sunshine weather-o-meter with a xenon lamp for 120 hours and allowed to stand in a thermo-hygrostat at 60° C. and 99 RH % for 7 days. The surface treating layer (hard coating layer and low refraction film) was tested for adhesion to the lens base material according to JISD-0202 (cross cut test). The surface of a lens sample was scribed with a knife in vertical and horizontal directions at intervals of 1 mm, so that 100 squares were made, each measuring 1 mm by 1 mm. A piece of cellophane tape (“Cello-Tape” from Nichiban Co., Ltd.) was firmly pressed against the squares and abruptly pulled in the direction at an angle of 90° to the surface. The number of squares of coating film remaining on the surface was visually counted. Adhesion was rated according to the following criterion.
⊚: 100 squares remain
◯: 95 to 99 squares remain
Δ: 50 to 94 squares remain
X: less than 49 squares remain

(3) Weather Resistance Test:

Weather resistance was evaluated by observing cracking after exposure to a sunshine weather-o-meter for 120 hours.

(4) Scratch Resistance Test:

The lens samples were rubbed with steel wool #0000 (from Nippon Steel Wool Co., Ltd.) to-and-fro ten times under a load of 1 kg. The rubbed samples were visually examined for scratches and rated according to the following criterion.

“1” (poor) to “10” (good)
⊚: 10-8
◯: 7-6
Δ: 5-4
X: 3-1

### Example 9

### (1) Formation of Hard Coating Layer

A mixture was made from 88 parts of propylene glycol methyl ether and 750 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 106 parts of γ-glycidoxypropyltrimethoxysilane and 25 parts of glycerol polyglycidyl ether (“Denacol EX-313” from Nagase Chemicals, Ltd.). To the resulting mixed solution was added dropwise with stirring 30 parts of 0.1 N aqueous solution of hydrochloric acid. The solution was stirred for 4 hours and allowed to stand for 24 hours. To the aged solution were added 1.6 parts of Fe(III) acetyl acetonate, 0.3 parts of silicone surfactant (“L-7001” from Nippon Unicar Company Limited), and 1.3 parts of phenol antioxidant (“Antage Crystal” from Kawaguchi Chemical Industry Co., Ltd.). Thus there was obtained a coating solution for the hard coating layer.

The coating solution was applied to the lens by dipping (with a lifting rate of 35 cm/min). Dipping was followed by air drying at 80° C. for 30 minutes and baking at 120° C. for 90 minutes. Thus there was obtained the desired hard coating layer, 2.3 μm thick.

### (2) Formation of Antireflection Film

The lens was placed horizontally in a basket and underwent plasma treatment for 60 seconds under the following conditions.

Degree of vacuum: 90 to 110×10⁻³ Torr

### Current: 70±10 mA

### Voltage: 0.6±0.1 kV

Then, the lens was coated with the coating solution C-1 for the low refraction film by dipping (with a lifting rate of 10 cm/min). Dipping was followed by air drying at 80° C. for 30 minutes and baking at 100° C. for 180 minutes. Thus there was obtained a low refraction film, about 100 nm thick. The lens was further treated with a fluorine-containing silane coupling agent to impart water repellency.

### Example 10

### (1) Formation of Hard Coating Layer

A mixture was made from 138 parts of propylene glycol methyl ether and 688 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 106 parts of _{Y}-glycidoxypropyltrimethoxysilane and 38 parts of glycerol polyglycidyl ether (“Denacol EX-313” from Nagase Chemicals, Ltd.). To the resulting mixed solution was added dropwise with stirring 30 parts of 0.1 N aqueous solution of hydrochloric acid. The solution was stirred for 4 hours and allowed to stand for 24 hours. To the aged solution were added 1.8 parts of Fe(III) acetyl acetonate, 0.3 parts of silicone surfactant (“L-7001” from Nippon Unicar Company Limited), and 1.3 parts of phenol antioxidant (“Antage Crystal” from Kawaguchi Chemical Industry Co., Ltd.). Thus there was obtained a coating solution for the hard coating layer. This coating solution was applied to the lens by dipping in the same way as in Example 9 to form the hard coating layer.

### (2) Formation of Antireflection Film

The lens underwent plasma treatment in the way as in Example 9. Then, the lens was coated with the coating solution C-1 for the low refraction film by dipping. Dipping was followed by baking. The lens was further treated with a fluorine-containing silane coupling agent to impart water repellency.

### Example 11

### (1) Formation of Hard Coating Layer

A mixture was made from 187 parts of propylene glycol methyl ether and 625 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 106 parts of _{Y}-glycidoxypropyltrimethoxysilane and 50 parts of glycerol polyglycidyl ether (“Denacol EX-313” from Nagase Chemicals, Ltd.). To the resulting mixed solution was added dropwise with stirring 30 parts of 0.1 N aqueous solution of hydrochloric acid. The solution was stirred for 4 hours and allowed to stand for 24 hours. To the aged solution were added 2.1 parts of Fe(III) acetyl acetonate, 0.7 parts of magnesium perchlorate, 0.3 parts of silicone surfactant (“L-7001” from Nippon Unicar Company Limited), and 1.3 parts of phenol antioxidant (“Antage Crystal” from Kawaguchi Chemical Industry Co., Ltd.). Thus there was obtained a coating solution for the hard coating layer. This coating solution was applied to the lens by dipping in the same way as in Example 5 to form the hard coating layer.

### (2) Formation of Antireflection Film

The lens underwent plasma treatment in the way as in Example 9. Then, the lens was coated with the coating solution C-1 for the low refraction film by dipping. Dipping was followed by baking. The lens was further treated with a fluorine-containing silane coupling agent to impart water repellency.

### Comparative Example 6

### (1) Formation of Hard Coating Layer

A mixture was made from 197 parts of propylene glycol methyl ether and 625 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 88 parts of γ-glycidoxypropyltrimethoxysilane and 63 parts of glycerol polyglycidyl ether (“Denacol EX-313” from Nagase Chemicals, Ltd.). To the resulting mixed solution was added dropwise with stirring 24 parts of 0.1 N aqueous solution of hydrochloric acid. The solution was stirred for 4 hours and allowed to stand for 24 hours. To the aged solution were added 2.2 parts of Fe(III) acetyl acetonate, 0.7 parts of magnesium perchlorate, 0.3 parts of silicone surfactant (“L-7001” from Nippon Unicar Company Limited), and 1.3 parts of phenol antioxidant (“Antage Crystal” from Kawaguchi Chemical Industry Co., Ltd.). This coating solution was applied to the lens by dipping in the same way as in Example 9 to form the hard coating layer.

### (2) Formation of Antireflection Film

The lens underwent plasma treatment in the way as in Example 9. Then, the lens was coated with the coating solution C-1 for the low refraction film by dipping. Dipping was followed by baking. The lens was further treated with a fluorine-containing silane coupling agent to impart water repellency.

### Comparative Example 7

### (1) Formation of Hard Coating Layer

A mixture was made from 152 parts of propylene glycol methyl ether and 625 parts of “Optolake 1120Z (8RU-25/A17)” commercially available from Catalysts & Chemicals Industries Co., Ltd. (“Optolake 1120Z (8RU-25/A17)” is a sol containing 20 wt % of inorganic oxide fine particles (having an average particle diameter of 8 nm) dispersed in methanol, the particle of which is formed from a nuclear particle composed of composite oxide of titanium oxide, tin oxide and silicon oxide with a rutile-type crystallite, and a coating layer composed of composite oxide of silicon oxide and zirconium oxide, and whose surface is further modified with a coupling agent.) The resulting mixture was further mixed with 170 parts of γ-glycidoxypropyltrimethoxysilane and 5 parts of glycerol polyglycidyl ether (“Denacol EX-313” from Nagase Chemicals, Ltd.). To the resulting mixed solution was added dropwise with stirring 47 parts of 0.1 N aqueous solution of hydrochloric acid. The solution was stirred for 4 hours and allowed to stand for 24 hours. To the aged solution were added 1.7 parts of Fe(III) acetyl acetonate, 0.5 parts of magnesium perchlorate 0.3 parts of silicone surfactant (“L-7001” from Nippon Unicar Company Limited), and 1.3 parts of phenol antioxidant (“Antage Crystal” from Kawaguchi Chemical Industry Co., Ltd.). This coating solution was applied to the lens by dipping in the same way as in Example 9 to form the hard coating layer.

### (2) Formation of Antireflection Film

The lens underwent plasma treatment in the way as in Example 9. Then, the lens was coated with the coating solution C-1 for the low refraction film by dipping. Dipping was followed by baking. The lens was further treated with a fluorine-containing silane coupling agent to impart water repellency.

Table 3 below shows the ratio (by weight) of solids (after baking) in the hard coating layer on the lens produced in Examples 9 to 11 and Comparative Examples 6 and 7. Table 4 below shows the results of evaluation test of the coating layer formed in these examples.

TABLE 3

| | | | | Comparative | |
|---|---|---|---|---|---|
| | Example | | | Example | |
| | 9 | 10 | 11 | 6 | 7 |
| Composite sol of rutile titanium oxide | 60 | 55 | 50 | 50 | 50 |
| Υ-glycidoxypropyltrimethoxysilane | 30 | 30 | 30 | 25 | 48 |
| Glycerol polyglycidyl ether | 10 | 15 | 20 | 25 | 2 |

TABLE 4

| | Heat | | Cracking due | Scratch |
|---|---|---|---|---|
| | resistance | Adhesion | to weathering | resistance |
| Example 9 | ⊚ | ⊚ | Not occurred | ⊚ |
| Example 10 | ⊚ | ⊚ | No occurred | ⊚ |
| Example 11 | ⊚ | ⊚ | No occurred | ⊚ |
| Comparative | ⊚ | ⊚ | No occurred | ◯ |
| Example 6 | | | | |
| Comparative | ◯ | ◯ | Occurred | ⊚ |
| Example 7 | | | | |

It is noted that the hard coating layer has good scratch resistance and sufficient hardness if the amount of glycerol polyglycidyl ether (as a polyfunctional epoxy compound) accounts for 4 to 22 wt % of the total solids as in Examples 9 to 11. It is also noted that the hard coating layer resists cracking after repeated heating in the heat resistance test on account of the well-balanced water resistance and flexibility. It is also noted that the hard coating layer excels in weather resistance as indicated by the results of cracking test to measure weather resistance.

The hard coating layer is poor in heat resistance and adhesion or is poor in hardness if the amount of the polyfunctional epoxy compound is excessively small or large, respectively.

### EXPLOITATION IN INDUSTRY

The plastic lens according to the present invention is clear without reflection and is superior in scratch resistance and weatherability. Therefore, it will find use as high-performance eyeglasses. In addition, the method for producing the plastic lens according to the present invention may be used to produce such high-performance plastic lenses.

1. A plastic lens composed of a plastic lens base material, a hard coating layer formed on the plastic lens base material, and an antireflection film formed on the hard coating layer, wherein the hard coating layer is one which is formed from a coating composition containing at least components (A) and (B) defined below,
(A) inorganic oxide fine particles having an average particle diameter of 1 to 200 nm and containing titanium oxide with a rutile-type crystallite,
(B) an organosilicon compound represented by the general formula of R¹SiX¹₃ (where R¹ denotes an organic group of carbon number 2 or more which has reactive groups capable of polymerization and X¹ denotes a hydrolyzable group),
and the antireflection film is an organic thin film which has a refractive index lower than that of the hard coating layer by no less than 0.10 and also has a thickness of 50 to 150 nm.

2. The plastic lens as defined in claim 1, wherein said inorganic oxide fine particles contain a composite oxide of titanium oxide and tin oxide or a composite oxide of titanium oxide, tin oxide and silicon oxide, with a rutile-type crystallite, and have an average particle diameter of 1 to 200 nm.

3. The plastic lens as defined in claim 2, wherein said inorganic oxide fine particles include those which have a core/shell type structure formed from (i) a nuclear particle composed of a composite oxide of titanium oxide and tin oxide or a composite oxide of titanium oxide, tin oxide and silicon oxide, with a rutile-type crystallite and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers said nuclear particle.

4. The plastic lens as defined in claim 1, wherein the antireflection film is an organic thin film formed from a coating composition containing the components (F) and (G) defined below:
(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1),
(G) silica fine particles having an average particle diameter of 1 to 150 nm.

5. The plastic lens as defined in claim 4, wherein the silica fine particles are hollow ones.

6. The plastic lens as defined in claim 5, wherein the silica fine particles are those which have an average particle diameter of 20 to 150 nm and a refractive index ranging from 1.16 to 1.39.

7. The plastic lens as defined in claim 1, wherein the coating composition for the hard coating layer further contains a polyfunctional epoxy compound as the component (C).

8. The plastic lens as defined in claim 1, wherein the coating composition for the hard coating layer further contains as the component (D) an organosilicon compound represented by the general formula of R²ₙSiX²₄₋ₙ, (where R² denotes a C₁₋₃ hydrocarbon group, X² denotes a hydrolyzable group, and n is 0 or 1).

9. The plastic lens as defined in claim 1, wherein the coating composition for the hard coating layer further contains as the component (E) a disilane compound represented by the formula X³₃₋ₘ—Si(R³ₘ)—Y—Si(R⁴ₘ)—X⁴₃₋ₘ (where R³ and R⁴ each denotes a C₁₋₆ hydrocarbon group, X³ and X⁴ each denotes a hydrolyzable group, Y denotes an organic group containing a carbonate group or epoxy group, and m is 0 or 1).

10. A method for producing a plastic lens which comprising the steps of:
forming on a plastic lens base material a hard coating layer from a coating composition containing at least the components (A) and (B) defined below,
(A) inorganic oxide fine particles having an average particle diameter of 1 to 200 nm and containing titanium oxide with a rutile-type crystallite,
(B) an organosilicon compound represented by the general formula of R¹SiX¹₃ (where R¹ denotes an organic group of carbon number 2 or more which has reactive groups capable of polymerization and X¹ denotes a hydrolyzable group); and
forming on the hard coating layer an organic thin film as an antireflection film which has a refractive index lower than that of said hard coating layer by no less than 0.10 and also has a thickness of 50 to 150 nm.

11. The method for producing a plastic lens as defined in claim 10, wherein said inorganic oxide fine particles contain a composite oxide of titanium oxide and tin oxide or a composite oxide of titanium oxide, tin oxide and silicon oxide, with a rutile-type crystallite, and have an average particle diameter of 1 to 200 nm.

12. The method for producing a plastic lens as defined in claim 11, wherein said inorganic oxide fine particles include those which have a core/shell type structure formed from (i) a nuclear particle composed of a composite oxide of titanium oxide and tin oxide or a composite oxide of titanium oxide, tin oxide and silicon oxide, with a rutile-type crystallite, and (ii) a coating layer composed of a composite oxide of silicon oxide and zirconium oxide, a composite oxide of silicon oxide and aluminum oxide or a composite oxide of silicon oxide, zirconium oxide and aluminum oxide, which covers said nuclear particle.

13. The method for producing a plastic lens as defined in claim 10, wherein the organic thin film as the antireflection film is formed from a coating composition containing the components (F) and (G) defined below,
(F) an organosilicon compound represented by the general formula of R⁵ᵣR⁶_{q}SiX⁵_{4-q-r} (where R⁵ denotes an organic group having reactive groups capable of polymerization; R⁶ denotes a C₁₋₆ hydrocarbon group; X⁵ denotes a hydrolyzable group; q is 0 or 1; and r is 0 or 1)
(G) silica fine particles having an average particle diameter of 1 to 150 nm.

14. The method for producing a plastic lens as defined in Claim 13, wherein the silica fine particles are hollow ones.

15. The method for producing a plastic lens as defined in claim 14, wherein the silica fine particles are those which have an average particle diameter of 20 to 150 nm and a refractive index ranging from 1.16 to 1.39.
